(19) United States
(12) Patent Application Publication
(10) Pub. No.: US 2023/0332618 A1
(43) Pub. Date: Oct. 19, 2023

(54) FLUID MACHINE

(71) Applicant: KABUSHIKI KAISHA TOYOTA JIDOSHOKKI, Kariya-shi, Aichi (JP)

(72) Inventors: Yuki OKANO, Aichi-ken (JP); Hiroshi SAITO, Aichi-ken (JP); Yuki ENDO, Aichi-ken (JP)

(73) Assignee: KABUSHIKI KAISHA TOYOTA JIDOSHOKKI, Kariya-shi, Aichi (JP)

(21) Appl. No.: 18/028,948

(22) PCT Filed: Aug. 6, 2021
(86) PCT No.: PCT/JP2021/029328

§ 371 Date: Mar. 28, 2023

(30) Foreign Application Priority Data
Sep. 30, 2020 (JP) 2020-165337

(51) Int. Cl. F04D 29/42; F04D 29/28; F04D 29/10

(52) U.S. Cl. CPC F04D 29/4213; F04D 29/284; F04D 29/102

(57) ABSTRACT

A fluid machine includes a projection, projecting from one surface toward the other surface, is provided in at least one gap among a gap between an outer peripheral surface of a rotary shaft and an inner peripheral surface of a through hole, a gap between a rear surface of a first impeller and a first facing surface of a partition wall, and a gap between a rear surface of a second impeller and a second facing surface of the partition wall. The projection cooperates with the other surface to form therebetween a clearance smaller than a first tip clearance between the first impeller and a first shroud surface of a housing and a second tip clearance between the second impeller and a second shroud surface of the housing. The projection has a collision surface that collides with the other surface when the first impeller and the second impeller vibrate.

### TECHNICAL FIELD

The present invention relates to a fluid machine.

### BACKGROUND ART

A known fluid machine including a first impeller and a second impeller is disclosed, for example, in Patent Literature 1. The first impeller rotates together with a rotary shaft so as to compress a fluid. The second impeller rotates together with the rotary shaft so as to compress the fluid that has been compressed by the first impeller. The rotary shaft is rotatably supported by a foil bearing. The foil bearing is disposed in a housing of the fluid machine.

The housing has a first impeller chamber in which the first impeller is accommodated and a second impeller chamber in which the second impeller is accommodated. The housing includes a partition wall that separates the first impeller chamber and the second impeller chamber. The housing has a first shroud surface and a second shroud surface. The first shroud surface cooperates with the partition wall to define the first impeller chamber and covers the outer periphery of the first impeller. The second shroud surface cooperates with the partition wall to define the second impeller chamber and covers the outer periphery of the second impeller. The first impeller and the second impeller are provided in the rotary shaft such that the rear surface of the first impeller and the rear surface of the second impeller face each other via the partition wall.

### CITATION LIST

### Patent Literature

Patent Literature 1: Japanese Patent Application Publication No. 2016-194252

### SUMMARY OF INVENTION

### Technical Problem

From the viewpoint of compression efficiency, such a fluid machine preferably has a minimum first tip clearance between the first impeller and the first shroud surface and a minimum second tip clearance between the second impeller and the second shroud surface. On the other hand, for example, there is a need to secure the first tip clearance and the second tip clearance to a certain degree so as to prevent that the first impeller and the second impeller respectively collide with the first shroud surface and the second shroud surface due to vibration of the first impeller and the second impeller which occurs with vibration of the rotary shaft. Accordingly, there is a problem that increasing the first tip clearance and the second tip clearance increases reliability of the fluid machine, but decreases the compression efficiency of the fluid machine.

The present invention has been devised in order to solve this problem, and an object of the present invention is to provide a fluid machine that is capable of increasing reliability while suppressing decrease of compression efficiency.

### Solution to Problem

A fluid machine for solving the problem includes: a rotary shaft; a first impeller configured to rotate together with the rotary shaft to compress a fluid; a second impeller configured to rotate together with the rotary shaft to compress the fluid that has been compressed by the first impeller; a housing having a first impeller chamber in which the first impeller is accommodated and a second impeller chamber in which the second impeller is accommodated; and a foil bearing disposed in the housing and supporting the rotary shaft rotatably, the housing including: a partition wall separating the first impeller chamber and the second impeller chamber; a first shroud surface cooperating with the partition wall to define the first impeller chamber and covering an outer periphery of the first impeller; and a second shroud surface cooperating with the partition wall to define the second impeller chamber and covering an outer periphery of the second impeller, the first impeller and the second impeller being provided in the rotary shaft such that a rear surface of the first impeller and a rear surface of the second impeller face each other via the partition wall, wherein the partition wall has: a first facing surface facing the rear surface of the first impeller in an axial direction of the rotary shaft; and a second facing surface facing the rear surface of the second impeller in the axial direction of the rotary shaft, the rotary shaft extends across the first impeller chamber and the second impeller chamber with the rotary shaft inserted through a through hole that penetrates through the partition wall, a projection projecting from one surface to the other surface is provided in at least one gap among a gap between an outer peripheral surface of the rotary shaft and an inner peripheral surface of the through hole, a gap between the rear surface of the first impeller and the first facing surface, and a gap between the rear surface of the second impeller and the second facing surface, the projection cooperates with the other surface facing the projection to form therebetween a clearance that is smaller than a first tip clearance between the first impeller and the first shroud surface and a second tip clearance between the second impeller and the second shroud surface, and the projection has a collision surface that collides with the other surface when the first impeller and the second impeller vibrate to prevent a contact of the first impeller and the first shroud surface and a contact of the second impeller and the second shroud surface.

According to this configuration, the collision surface of the projection restricts vibration of the rotary shaft before the first impeller vibrates and collides with the first shroud surface and the second impeller vibrates and collides with the second shroud surface. This prevents the first impeller from vibrating and colliding with the first shroud surface and the second impeller from vibrating and colliding with the second shroud surface, thereby increasing reliability of the fluid machine. Furthermore, this eliminates the need to secure the first tip clearance and the second tip clearance to a certain degree so as to prevent the first impeller from vibrating and colliding with the first shroud surface and the second impeller from vibrating and colliding with the second shroud surface, thereby suppressing decrease of compression efficiency of the fluid machine. Accordingly, the fluid machine is capable of increasing the reliability while suppressing the decrease of the compression efficiency.

In the fluid machine, the first tip clearance may include a first radial clearance that extends in a radial direction between the first impeller and the first shroud surface, the second tip clearance may include a second radial clearance that extends in the radial direction between the second impeller and the second shroud surface, and the projection may include a radial projection that has an annular shape, projects in the radial direction from at least one of the inner peripheral surface of the through hole and the rotary shaft, and forms a clearance that is smaller than the first radial clearance and the second radial clearance in the radial direction.

According to this configuration, the radial projection restricts the vibration of the rotary shaft in the radial direction before the first impeller vibrates in the radial direction and collides with the first shroud surface and the second impeller vibrates in the radial direction and collides with the second shroud surface. This prevents the first impeller from vibrating in the radial direction and colliding with the first shroud surface and the second impeller from vibrating in the radial direction and colliding with the second shroud surface, thereby increasing the reliability of the fluid machine. This eliminates the need to secure the first radial clearance and the second radial clearance to a certain degree so as to prevent the first impeller from vibrating in the radial direction and colliding with the first shroud surface and the second impeller from vibrating in the radial direction and colliding with the second shroud surface, thereby suppressing the decrease of the compression efficiency of the fluid machine. Accordingly, the fluid machine is capable of increasing the reliability while suppressing the decrease of the compression efficiency.

In the fluid machine, the first tip clearance may include a first thrust clearance that extends in a thrust direction between the first impeller and the first shroud surface, the second tip clearance may include a second thrust clearance that extends in the thrust direction between the second impeller and the second shroud surface, and the projection may include at least one of a first thrust projection having an annular shape and a second thrust projection having an annular shape, wherein the first thrust projection projects in the thrust direction from at least one of the rear surface of the first impeller and the first facing surface and forms a clearance that is smaller than the first thrust clearance and the second thrust clearance in the thrust direction, and the second thrust projection projects in the thrust direction from at least one of the rear surface of the second impeller and the second facing surface and forms a clearance that is smaller than the first thrust clearance and the second thrust clearance in the thrust direction.

According to this configuration, the first thrust projection restricts the vibration of the rotary shaft in the thrust direction before the first impeller vibrates in the thrust direction and collides with the first shroud surface and the second impeller vibrates in the thrust direction and collides with the second shroud surface. The second thrust projection restricts the vibration of the rotary shaft in the thrust direction before the first impeller vibrates in the thrust direction and collides with the first shroud surface and the second impeller vibrates in the thrust direction and collides with the second shroud surface. This prevents the first impeller from vibrating in the thrust direction and colliding with the first shroud surface and the second impeller from vibrating in the thrust direction and colliding with the second shroud surface, thereby increasing the reliability of the fluid machine. This eliminates the need to secure the first thrust clearance and the second thrust clearance to a certain degree so as to prevent the first impeller from vibrating in the thrust direction and colliding with the first shroud surface and the second impeller from vibrating in the thrust direction and colliding with the second shroud surface, thereby suppressing the decrease of the compression efficiency of the fluid machine. Accordingly, the fluid machine is capable of increasing the reliability while suppressing the decrease of the compression efficiency.

In the fluid machine, the second impeller may be disposed closer to one end of the rotary shaft than the first impeller is, the foil bearing may be disposed closer to the other end of the rotary shaft than the first impeller and the second impeller are, and the projection may be disposed at a position closer to the second impeller than to the first impeller.

For example, when the rotary shaft swings, run-out of the rotary shaft is larger in a portion farther from the foil bearing. Since the projection is disposed at a position closer to the second impeller than to the first impeller, the projection may be disposed, relative to the rotary shaft, at a position distant from the foil bearing, for example, compared with a case where the projection is disposed at a position closer to the first impeller than to the second impeller. This configuration allows the projection to easily suppress the run-out of the rotary shaft when the rotary shaft swings before the first impeller vibrates and collides with the first shroud surface and the second impeller vibrates and collides with the second shroud surface, for example. This configuration therefore easily prevents the first impeller from vibrating and colliding with the first shroud surface and the second impeller from vibrating and colliding with the second shroud surface, for example.

In the fluid machine, the radial projection may project from the inner peripheral surface of the through hole toward the rotary shaft, and an inner diameter of the radial projection may be smaller than a minimum diameter of the first impeller and a minimum diameter of the second impeller.

Compared with a case where the inner diameter of the radial projection is equal to or larger than the minimum diameter of the first impeller and the minimum diameter of the second impeller, for example, this configuration decreases the peripheral velocity of the rotary shaft at the time of the collision of the rotary shaft with the collision surface of the radial projection, thereby reducing a load applied to the radial projection.

In the fluid machine, the fluid machine may include a seal portion that seals the gap between the rotary shaft and the inner peripheral surface of the through hole, and the radial projection is disposed at a position not overlapping the seal portion.

This configuration allows the seal portion to suitably seal the gap between the rotary shaft and the inner peripheral surface of the through hole and prevents the first impeller from vibrating in the radial direction and colliding with the first shroud surface and the second impeller from vibrating in the radial direction and colliding with the second shroud surface. This therefore further increases the reliability of the fluid machine.

In the fluid machine, the foil bearing may include: a top foil supporting the rotary shaft rotatably without contacting the rotary shaft during rotation of the rotary shaft; and a bump foil elastically supporting the top foil, and the clearance formed by the projection is set to size that allows deformation of the bump foil in an elastic region.

Even in the fluid machine including the projection, this configuration allows the deformation of the bump foil in the elastic region due to a dynamic pressure when the dynamic pressure is generated between the rotary shaft and the top foil during the rotation of the rotary shaft. This configuration therefore allows the top foil to support the rotary shaft rotatably without contacting the rotary shaft.

### Advantageous Effect of Invention

The present invention allows increase of reliability while suppressing decrease of compression efficiency.

### BRIEF DESCRIPTION OF DRAWINGS

FIG. 1 is a sectional side view of a fluid machine according to an embodiment.

FIG. 2 is an enlarged sectional view of a radial projection and its surroundings.

FIG. 3 is a longitudinal sectional view of a first foil bearing and a rotary shaft.

FIG. 4 is a partially enlarged sectional view of a fluid machine according to another embodiment.

FIG. 5 is a partially enlarged sectional view of a fluid machine according to another embodiment.

FIG. 6 is a partially enlarged sectional view of a fluid machine according to another embodiment.

FIG. 7 is a partially enlarged sectional view of a fluid machine according to another embodiment.

### DESCRIPTION OF EMBODIMENTS

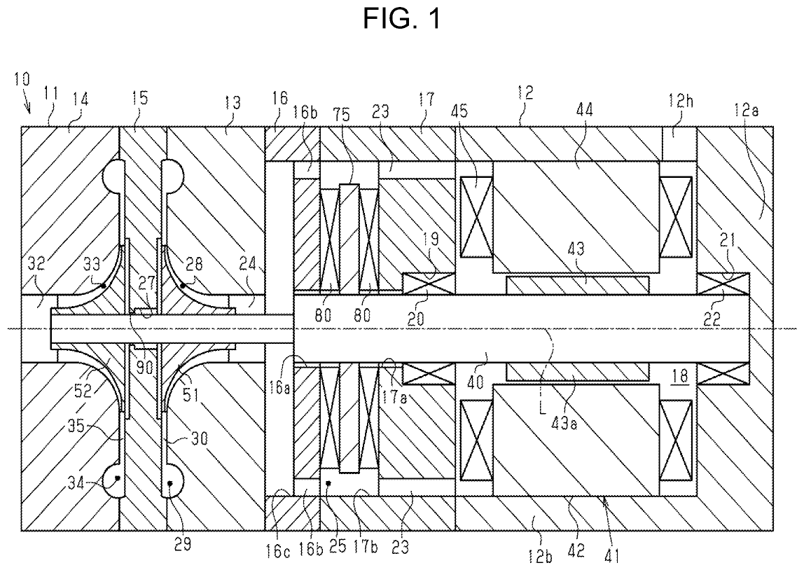

An embodiment embodying a fluid machine is explained below with reference to FIG. 1 to FIG. 3. The fluid machine according to the embodiment is mounted on a fuel cell vehicle. The fuel cell vehicle includes a fuel cell system that supplies oxygen and hydrogen to a fuel cell for power generation. The fluid machine compresses air serving as a fluid that contains the oxygen supplied to the fuel cell.

As illustrated in FIG. 1, a fluid machine 10 includes a housing 11 having a tubular shape. The housing 11 includes a motor housing 12, a first compressor housing 13, a second compressor housing 14, a partition wall 15, a first intermediate housing 16, and a second intermediate housing 17. The motor housing 12, the first compressor housing 13, the second compressor housing 14, the partition wall 15, the first intermediate housing 16, and the second intermediate housing 17 are each made of a metal material, such as aluminum.

The motor housing 12 has a bottomed tubular shape, and includes an end wall 12a having a plate-like shape and a peripheral wall 12b extending in a tubular shape from the outer peripheral portion of the end wall 12a. The second intermediate housing 17 is coupled to the motor housing 12 with closing an opening of the peripheral wall 12b that is distant from the end wall 12a. The second intermediate housing 17 cooperates with the end wall 12a and the peripheral wall 12b of the motor housing 12 to define a motor chamber 18. The peripheral wall 12b has, in a part adjacent to the end wall 12a, a suction hole 12h for introducing air. The suction hole 12h is connected to the motor chamber 18. Accordingly, the air is introduced into the motor chamber 18 through the suction hole 12h.

The second intermediate housing 17 has a shaft insertion hole 17a that has a circular hole shape and is formed in the center portion of the second intermediate housing 17. The second intermediate housing 17 includes a first bearing holding portion 19 that has a cylindrical shape. The first bearing holding portion 19 is formed in the center portion of the second intermediate housing 17. The inside of the first bearing holding portion 19 is connected to the shaft insertion hole 17a. The axis of the first bearing holding portion 19 corresponds to the axis of the shaft insertion hole 17a. The first bearing holding portion 19 holds a first foil bearing 20 that serves as a foil bearing.

The end wall 12a of the motor housing 12 includes a second bearing holding portion 21 having a cylindrical shape. The second bearing holding portion 21 is formed in the center portion of the end wall 12a of the motor housing 12. The axis of the first bearing holding portion 19 corresponds to the axis of the second bearing holding portion 21. The second bearing holding portion 21 holds a second foil bearing 22 that serves as the foil bearing. Accordingly, the first foil bearing 20 and the second foil bearing 22 are disposed in the housing 11.

The second intermediate housing 17 has a first chamber forming recess 17b in an outer surface of the second intermediate housing 17 that is distant from the motor chamber 18. The first chamber forming recess 17b is connected to the shaft insertion hole 17a. The second intermediate housing 17 has a plurality of communication holes 23. Each of the communication holes 23 is located in a part adjacent to the outer periphery of the second intermediate housing 17. Each of the communication holes 23 penetrates through the second intermediate housing 17. The communication holes 23 connects the motor chamber 18 and the first chamber forming recess 17b.

The first intermediate housing 16 is coupled to the second intermediate housing 17. The first intermediate housing 16 is coupled to the second intermediate housing 17 with closing an opening of the first chamber forming recess 17b. The first intermediate housing 16 cooperates with the first chamber forming recess 17b of the second intermediate housing 17 to define a thrust bearing accommodation chamber 25. The first intermediate housing 16 has a shaft insertion hole 16a that has a circular hole shape and is formed in the center portion of the first intermediate housing 16.

The first intermediate housing 16 has a plurality of communication holes 16b. Each of the communication holes 16b is located in a part adjacent to the outer periphery of the first intermediate housing 16. Each of the communication holes 16b penetrates through the first intermediate housing 16. The first intermediate housing 16 has a second chamber forming recess 16c in an outer surface of the first intermediate housing 16 that is distant from the thrust bearing accommodation chamber 25. The second chamber forming recess 16c is connected to the shaft insertion hole 16a. Each of the communication holes 16b connects the thrust bearing accommodation chamber 25 and the second chamber forming recess 16c.

The first compressor housing 13 has a tubular shape, and has a first suction port 24 which has a circular hole shape and into which air is introduced. The first compressor housing 13 is coupled to the first intermediate housing 16 with the axis of the first suction port 24 corresponding to the axis of the shaft insertion hole 16a. The first suction port 24 is connected to the second chamber forming recess 16c.

The partition wall 15 is coupled to an end face of the first compressor housing 13 that is distant from the first intermediate housing 16. The partition wall 15 has a plate-like shape. The partition wall 15 has a through hole 27 that has a circular hole shape and is formed in the center portion of the partition wall 15. The through hole 27 penetrates through the partition wall 15 in the thickness direction of the partition wall 15. The partition wall 15 is coupled to the first compressor housing 13 with the axis of the through hole 27 corresponding to the axis of the first suction port 24. The first suction port 24 faces the partition wall 15 in a direction in which the axis of the first suction port 24 extends.

A first impeller chamber 28 connected to the first suction port 24, a first discharge chamber 29 extending around the first impeller chamber 28 about the axis of the first suction port 24, and a first diffuser channel 30 through which the first impeller chamber 28 is connected to the first discharge chamber 29 are formed between the partition wall 15 and the first compressor housing 13.

The second compressor housing 14 has a tubular shape and has a second suction port 32 which has a circular hole shape and into which air is introduced. The second compressor housing 14 is coupled to an end face of the partition wall 15 that is distant from the first compressor housing 13 with the axis of the second suction port 32 corresponding to the axis of the first suction port 24. The second suction port 32 faces the partition wall 15 in a direction in which the axis of the second suction port 32 extends.

A second impeller chamber 33 connected to the second suction port 32, a second discharge chamber 34 extending around the second impeller chamber 33 about the axis of the second suction port 32, and a second diffuser channel through which the second impeller chamber 33 is connected to the second discharge chamber 34 are formed between the partition wall 15 and the second compressor housing 14. Accordingly, the housing 11 has the first impeller chamber 28 and the second impeller chamber 33. The partition wall 15 separates the first impeller chamber 28 and the second impeller chamber 33. The first discharge chamber 29 is connected to the second suction port 32 through a channel that is not illustrated.

The fluid machine 10 includes a rotary shaft 40 and an electric motor 41 that rotates the rotary shaft 40. The electric motor 41 is accommodated in the motor chamber 18. The rotary shaft 40 extends in the axial direction of the housing 11 while passing, from the inside of the second bearing holding portion 21, through the motor chamber 18, the inside of the first bearing holding portion 19, the shaft insertion hole 17a, the thrust bearing accommodation chamber 25, the shaft insertion hole 16a, the first suction port 24, the first impeller chamber 28, the through hole 27, the second impeller chamber 33, and the second suction port 32 in this order. Accordingly, the rotary shaft 40 extends across the first impeller chamber 28 and the second impeller chamber 33 with the rotary shaft inserted through the through hole 27. An axis L of the rotary shaft 40 corresponds to the axis of each of the first bearing holding portion 19, the second bearing holding portion 21, the shaft insertion hole 17a, the shaft insertion hole 16a, the first suction port 24, the through hole 27, and the second suction port 32. Note that, in the following explanation, “the axial direction of the rotary shaft 40”, which is a direction in which the axis L of the rotary shaft 40 extends, is sometimes described as “thrust direction” and “the radial direction of the rotary shaft 40” is sometimes described as “radial direction”.

The electric motor 41 includes a stator 42 and a rotor 43. The stator 42 includes a stator core 44 having a cylindrical shape and a coil 45 wound around the stator core 44. The stator core 44 is fixed to the inner peripheral surface of the peripheral wall 12b of the motor housing 12. The rotor 43 is disposed inside the stator core 44 in the motor chamber 18. The rotor 43 rotates together with the rotary shaft 40. The rotor 43 includes a rotor core 43a fixed to the rotary shaft 40 and a plurality of permanent magnets, which are not illustrated, provided in the rotor core 43a. Electric power controlled by an inverter device, which is not illustrated, is supplied to the coil 45 to rotate the rotor 43, so that the rotary shaft 40 rotates together with the rotor 43.

The fluid machine 10 includes a first impeller 51 and a second impeller 52. The first impeller 51 and the second impeller 52 are made of, for example, aluminum. Note that the rigidity of the aluminum material of the first impeller 51 and the second impeller 52 is lower than the rigidity of the aluminum material of the partition wall 15. The first impeller 51 and the second impeller 52 are coupled to one end of the rotary shaft 40. The second impeller 52 is disposed closer to the one end of the rotary shaft 40 than the first impeller 51 is. The first foil bearing 20 and the second foil bearing 22 are disposed closer to the other end of the rotary shaft 40 than the first impeller 51 and the second impeller 52 are.

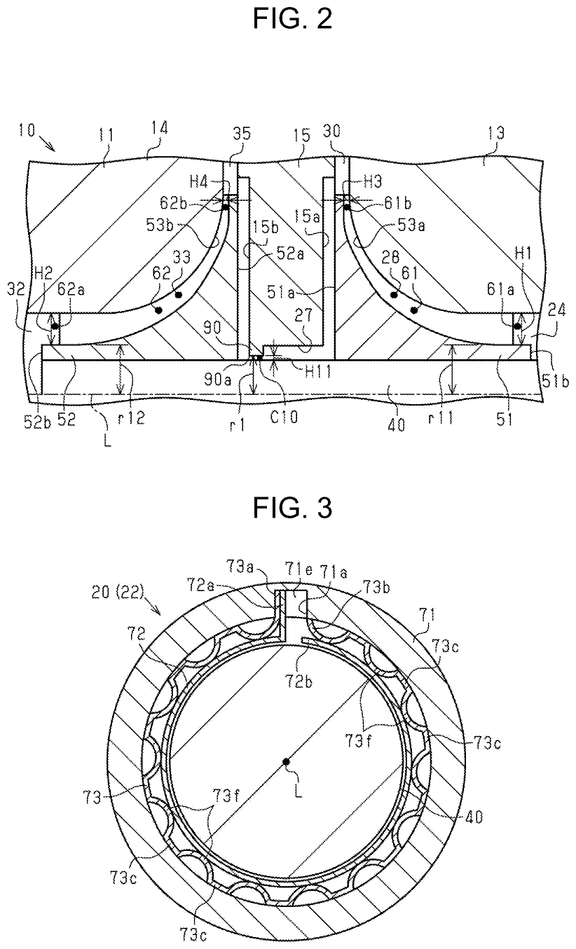

As illustrated in FIG. 2, the first impeller 51 is accommodated in the first impeller chamber 28. The first impeller 51 has a truncated cone shape gradually reduced in diameter from a rear surface 51a of the first impeller 51 toward a distal end face 51b of the first impeller 51. The first impeller 51 is coupled to the one end of the rotary shaft 40 with the rear surface 51a facing the partition wall 15 in the axial direction of the rotary shaft 40. Accordingly, the partition wall 15 has a first facing surface 15a facing the rear surface 51a of the first impeller 51 in the axial direction of the rotary shaft 40. The first impeller 51 rotates together with the rotary shaft 40 to compress air.

The second impeller 52 is accommodated in the second impeller chamber 33. The second impeller 52 has a truncated cone shape gradually reduced in diameter from a rear surface 52a of the second impeller 52 toward a distal end face 52b of the second impeller 52. The second impeller 52 is coupled to one end of the rotary shaft 40 with the rear surface 52a facing the partition wall 15 in the axial direction of the rotary shaft 40. Accordingly, the partition wall 15 has a second facing surface 15b facing the rear surface 52a of the second impeller 52 in the axial direction of the rotary shaft 40. The second impeller 52 rotates together with the rotary shaft 40 to compress the air that has been compressed by the first impeller 51. The first impeller 51 and the second impeller 52 are provided in the rotary shaft 40 such that the rear surface 51a of the first impeller 51 and the rear surface 52a of the second impeller 52 face each other via the partition wall 15.

The first compressor housing 13 has a first shroud surface 53a that cooperates with the partition wall 15 to define the first impeller chamber 28. The first shroud surface 53a has a truncated cone shape to cover the outer periphery of the first impeller 51. The first shroud surface 53a extends along the outer periphery of the first impeller 51 from the rear surface 51a of the first impeller 51 to the distal end face 51b of the first impeller 51. A first tip clearance 61 is formed between the first impeller 51 and the first shroud surface 53a. The first tip clearance 61 between the first impeller 51 and the first shroud surface 53a is a clearance, between the outer periphery of the first impeller 51 and the first shroud surface 53a, extending from the distal end face 51b of the first impeller 51 to the rear surface 51a of the first impeller 51.

The first tip clearance 61 includes a first radial clearance 61a that extends in the radial direction between a part of the outer periphery of the first impeller 51 adjacent to the distal end face 51b and the first shroud surface 53a. The first tip clearance 61 includes a first thrust clearance 61b that extends in the thrust direction between a part of the outer periphery of the first impeller 51 adjacent to the rear surface 51a and the first shroud surface 53a.

The second compressor housing 14 includes a second shroud surface 53b that cooperates with the partition wall 15 to define the second impeller chamber 33. The second shroud surface 53b has a truncated cone shape to cover the outer periphery of the second impeller 52. The second shroud surface 53b extends along the outer periphery of the second impeller 52 from the rear surface 52a of the second impeller 52 to the distal end face 52b of the second impeller 52. A second tip clearance 62 is formed between the second impeller 52 and the second shroud surface 53b. The second tip clearance 62 between the second impeller 52 and the second shroud surface 53b is a clearance, between the outer periphery of the second impeller 52 and the second shroud surface 53b, extending from the distal end face 52b of the second impeller 52 to the rear surface 52a of the second impeller 52.

The second tip clearance 62 includes a second radial clearance 62a that extends in the radial direction between a part of the outer periphery of the second impeller 52 adjacent to on the distal end face 52b and the second shroud surface 53b. The second tip clearance 62 includes a second thrust clearance 62b that extends in the thrust direction between a part of the outer periphery of the second impeller 52 adjacent to the rear surface 52a and the second shroud surface 53b.

Length H1 of the first radial clearance 61a is equal to length H2 of the second radial clearance 62a. Length H3 of the first thrust clearance 61b is equal to length H4 of the second thrust clearance 62b.

As illustrated in FIG. 1, the first foil bearing 20 and the second foil bearing 22 support the rotary shaft 40 rotatably. The first foil bearing 20 and the second foil bearing 22 support the rotary shaft 40 with contacting the rotary shaft until the rotating speed of the rotary shaft 40 reaches a floating rotational speed at which the rotary shaft 40 floats off the first foil bearing 20 and the second foil bearing 22. When the rotating speed of the rotary shaft 40 reaches the floating rotational speed, the rotary shaft 40 floats off the first foil bearing 20 and the second foil bearing 22 due to a dynamic pressure generated between the rotary shaft 40 and the first foil bearing 20 and between the rotary shaft 40 and the second foil bearing 22, so that the rotary shaft 40 is rotatably supported without contacting the first foil bearing 20 and the second foil bearing 22. That is, the first foil bearing 20 and the second foil bearing 22 are aerodynamic bearings that support the rotary shaft 40 rotatably in the radial direction.

Next, a specific configuration of the first foil bearing 20 will be explained. Note that, since the configuration of the second foil bearing 22 is the same as the configuration of the first foil bearing 20, detailed explanation of the configuration of the second foil bearing 22 will be omitted.

As illustrated in FIG. 3, the first foil bearing 20 includes a bearing housing 71, a top foil 72, and a bump foil 73. The bearing housing 71 has a cylindrical shape. The inner peripheral surface of the bearing housing 71 has a holding groove 71a. The holding groove 71a extends in the axial direction of the bearing housing 71. One end of the holding groove 71a in the axial direction is opened on the end face of one end of the bearing housing 71 in the axial direction. The other end of the holding groove 71a in the axial direction is not opened on the end face of the other end of the bearing housing 71 in the axial direction, so that the other end of the holding groove 71a is closed. Accordingly, the other end of the holding groove 71a in the axial direction has a step surface 71e that extends in the radial direction of the bearing housing 71 and continues to the inner peripheral surface of the bearing housing 71.

The top foil 72 has a substantially cylindrical shape. The top foil 72 is formed by, for example, bending a metal plate having a belt-like shape and flexibility, which is made of stainless steel or the like, into a tubular shape, with the long side direction of the metal plate set as the circumferential direction of the top foil 72 and with the short side direction of the metal plate set as the axial direction of the top foil 72. One end portion of the top foil 72 in the circumferential direction, which is a fixed end portion 72a, is outwardly bent in the radial direction of the top foil 72. The other end portion of the top foil 72 in the circumferential direction, which is a free end portion 72b, is separated away from the base end portion of the fixed end portion 72a in the circumferential direction and faces the base end portion of the fixed end portion 72a. Accordingly, the top foil 72 has an incomplete ring shape with a partial cutout.

The top foil 72 is disposed inside the bearing housing 71 with the fixed end portion 72a inserted into the holding groove 71a. The fixed end portion 72a is inserted into the holding groove 71a, so that the top foil 72 is disposed inside the bearing housing 71 with the fixed end portion 72a held by the holding groove 71a. The top foil 72 is disposed outward of the rotary shaft 40 in the radial direction. The top foil 72 supports the rotary shaft 40 rotatably without contacting the rotary shaft 40 during rotation of the rotary shaft 40.

The bump foil 73 has a substantially cylindrical shape. The bump foil 73 is formed by, for example, bending a metal corrugated plate having a belt-like shape and flexibility, which is made of stainless steel or the like, into a tubular shape, with the long side direction of the metal plate set as the circumferential direction of the bump foil 73 and with the short side direction of the metal plate set as the axial direction of the bump foil 73. The thickness of the top foil 72 is substantially equal to the thickness of the bump foil 73. One end portion of the bump foil 73 in the circumferential direction, which is a fixed end portion 73a, is outwardly bent in the radial direction of the bump foil 73. The other end portion of the bump foil 73 in the circumferential direction, which is a free end portion 73b, is separated away from the base end portion of the fixed end portion 73a in the circumferential direction and faces the base end portion of the fixed end portion 73a. Accordingly, the bump foil 73 has an incomplete ring shape with a partial cutout.

The bump foil 73 is disposed inside the bearing housing 71 with the fixed end portion 73a inserted into the holding groove 71a. The fixed end portion 73a is inserted into the holding groove 71a, so that the bump foil 73 is disposed inside the bearing housing 71 with the fixed end portion 73a held by the holding groove 71a. The bump foil 73 is disposed between the inner peripheral surface of the bearing housing 71 and the top foil 72. Accordingly, the bump foil 73 is disposed outward of the top foil 72 in the radial direction. The bump foil 73 elastically supports the top foil 72.

The bump foil 73 includes a plurality of trough portions 73c that are in contact with the inner peripheral surface of the bearing housing 71. Each of the trough portions 73c extends along the inner peripheral surface of the bearing housing 71. The bump foil 73 includes a plurality of ridge portions 73f that are in contact with the outer peripheral surface of the top foil 72. Each of the ridge portions 73f is curved in an arcuate shape to be separated from the inner peripheral surface of the bearing housing 71 and swell toward the outer peripheral surface of the top foil 72. The bump foil 73 has a corrugated shape in which the trough portions 73c and the ridge portions 73f are alternately arranged in the circumferential direction of the bump foil 73.

While the rotary shaft 40 is not rotating, each of the trough portions 73c of the bump foil 73 is in contact with the inner peripheral surface of the bearing housing 71 and each of the ridge portions 73f of the bump foil 73 is in contact with the outer peripheral surface of the top foil 72. When the rotary shaft 40 rotates, the top foil 72 is elastically deformed outwardly in the radial direction, so that air enters a gap between the rotary shaft 40 and the top foil 72 to produce an air film, thereby generating a dynamic pressure. Accordingly, the rotary shaft 40 is rotatably supported by the top foil 72 via the air film without contacting the top foil 72.

When the top foil 72 is elastically deformed outwardly in the radial direction by the air film produced between the rotary shaft 40 and the top foil 72, each of the ridge portions 73f of the bump foil 73 in contact with the outer peripheral surface of the top foil 72 is pressed by the top foil 72, so that the bump foil 73 is elastically deformed outwardly in the radial direction along with the top foil 72. Accordingly, the top foil 72 is elastically supported by the bump foil 73. Consequently, each of the ridge portions 73f of the bump foil 73 is elastically deformed by outward displacement of the top foil 72 in the radial direction.

As illustrated in FIG. 1, the fluid machine 10 includes a support plate 75 that has a disc shape and is provided in the rotary shaft 40. The support plate 75 projects from the outer peripheral surface of the rotary shaft 40. The support plate 75 is pressed into the outer peripheral surface of the rotary shaft 40. The support plate 75 rotates together with the rotary shaft 40. The support plate 75 is disposed in the thrust bearing accommodation chamber 25.

Two thrust bearings 80 are respectively disposed between the first intermediate housing 16 and the support plate 75 and between the second intermediate housing 17 and the support plate 75. When the support plate 75 rotates with the rotation of the rotary shaft 40, a dynamic pressure is generated between the support plate 75 and the thrust bearings 80. Accordingly, the support plate 75 floats off both the thrust bearings 80, and is rotatably supported by the thrust bearings 80 without contacting both the thrust bearings 80. That is, both the thrust bearings 80 are aerodynamic bearings that support the rotary shaft 40 rotatably in the thrust direction.

In the fluid machine 10, air is introduced into the motor chamber 18 from the suction hole 12h. The air introduced into the motor chamber 18 is introduced into the first suction port 24, and passes through each of the communication holes 23, the thrust bearing accommodation chamber 25, each of the communication holes 16b, and the inside of the second chamber forming recess 16c. The air introduced into the first suction port 24 is raised in pressure by centrifugal action of the first impeller 51, fed into the first diffuser channel 30 from the first impeller chamber 28, and further raised in pressure in the first diffuser channel 30. The air passed through the first diffuser channel 30 is discharged to the first discharge chamber 29.

The air discharged to the first discharge chamber 29 is introduced into the second suction port 32 from the first discharge chamber 29 through a passage that is not illustrated. The air introduced into the second suction port 32 is raised in pressure by centrifugal action of the second impeller 52, fed into the second diffuser channel 35 from the second impeller chamber 33, and further raised in pressure in the second diffuser channel 35. The air passed through the second diffuser channel 35 is discharged to the second discharge chamber 34.

As illustrated in FIG. 2, the fluid machine 10 includes a radial projection 90 having an annular shape. The radial projection 90 projects in the radial direction from the inner peripheral surface of the through hole 27. The radial projection 90 projects from the inner peripheral surface of the through hole 27 toward the outer peripheral surface of the rotary shaft 40. That is, the radial projection 90 is provided in a gap between the outer peripheral surface of the rotary shaft 40 and the inner peripheral surface of the through hole 27. The radial projection 90 is a projection projecting from one surface of the inner peripheral surface of the through hole 27 and the outer peripheral surface of the rotary shaft 40 toward the other surface of the inner peripheral surface of the through hole 27 and the outer peripheral surface of the rotary shaft 40. The inner peripheral surface of the radial projection 90 is a collision surface 90a that collides with the outer peripheral surface of the rotary shaft 40 when the first impeller 51 and the second impeller 52 vibrate.

The radial projection 90 is located at an end portion of the inner peripheral surface of the through hole 27 adjacent to the second facing surface 15b. Accordingly, the radial projection 90 is disposed at a position closer to the second impeller 52 than to the first impeller 51. The radial projection 90 continues to the second facing surface 15b. The radial projection 90 is formed integrally with the partition wall 15. Accordingly, the radial projection 90 is made of aluminum.

Length H11 of a clearance C10 between the collision surface 90a of the radial projection 90 and the outer peripheral surface of the rotary shaft 40 in the radial direction is smaller than the length H1 of the first radial clearance 61a and the length H2 of the second radial clearance 62a. Accordingly, the radial projection 90 cooperates with the outer peripheral surface of the rotary shaft 40 facing the radial projection 90 to form therebetween the clearance C10, which is smaller than the first radial clearance 61a and the second radial clearance 62a in the radial direction.

An inner diameter r1 of the radial projection 90 is smaller than an outer diameter r11 of the distal end face 51b of the first impeller 51 and an outer diameter r12 of the distal end face 52b of the second impeller 52. The outer diameter r11 of the distal end face 51b of the first impeller 51 is a minimum diameter of the first impeller 51. The outer diameter r12 of the distal end face 52b of the second impeller 52 is a minimum diameter of the second impeller 52. Therefore, the inner diameter r1 of the radial projection 90 is smaller than the minimum diameter of the first impeller 51 and the minimum diameter of the second impeller 52. The clearance C10 formed by the radial projection 90 is set to size that allows deformation of the bump foil 73 in an elastic region.

Next, operation according to this embodiment will be explained.

For example, when the first impeller 51 and the second impeller 52 vibrate with the vibration of the rotary shaft 40, the first impeller 51 may vibrate in the radial direction and the second impeller 52 may vibrate in the radial direction. The radial projection 90 cooperates with the outer peripheral surface of the rotary shaft 40 facing the radial projection 90 to form therebetween the clearance C10, which is smaller than the first radial clearance 61a and the second radial clearance 62a in the radial direction. Accordingly, the outer peripheral surface of the rotary shaft 40 collides with the collision surface 90a of the radial projection 90 before the first impeller 51 vibrates in the radial direction and collides with the first shroud surface 53a and the second impeller 52 vibrates in the radial direction and collides with the second shroud surface 53b. That is, the collision surface 90a of the radial projection 90 restricts the vibration of the rotary shaft 40 in the radial direction before the first impeller 51 vibrates in the radial direction and collides with the first shroud surface 53a and the second impeller 52 vibrates in the radial direction and collides with the second shroud surface 53b. This prevents the first impeller 51 from vibrating in the radial direction and colliding with the first shroud surface 53a and the second impeller 52 from vibrating in the radial direction and colliding with the second shroud surface 53b.

The embodiment provides following effects.
(1) The collision surface 90a of the radial projection 90 restricts the vibration of the rotary shaft 40 before the first impeller 51 vibrates and collides with the first shroud surface 53a and the second impeller 52 vibrates and collides with the second shroud surface 53b. This prevents the first impeller 51 from vibrating and colliding with the first shroud surface 53a and the second impeller 52 from vibrating and colliding with the second shroud surface 53b, thereby increasing reliability of the fluid machine 10. Furthermore, this eliminates the need to secure the first tip clearance 61 and the second tip clearance 62 to a certain degree so as to prevent the first impeller 51 from vibrating and colliding with the first shroud surface 53a and the second impeller 52 from vibrating and colliding with the second shroud surface 53b, thereby suppressing decrease of compression efficiency of the fluid machine 10. Accordingly, the fluid machine is capable of increasing the reliability while suppressing the decrease of the compression efficiency.
(2) The radial projection 90 restricts the vibration of the rotary shaft 40 in the radial direction before the first impeller 51 vibrates in the radial direction and collides with the first shroud surface 53a and the second impeller 52 vibrates in the radial direction and collides with the second shroud surface 53b. This prevents the first impeller 51 from vibrating in the radial direction and colliding with the first shroud surface 53a and the second impeller 52 from vibrating in the radial direction and colliding with the second shroud surface 53b. Furthermore, this eliminates the need to secure the first radial clearance 61a and the second radial clearance 62a to a certain degree so as to prevent the first impeller 51 from vibrating in the radial direction and colliding with the first shroud surface 53a and the second impeller 52 from vibrating in the radial direction and colliding with the second shroud surface 53b. This therefore suppresses the decrease of the compression efficiency of the fluid machine 10.
(3) For example, when the rotary shaft 40 swings, the run-out of the rotary shaft 40 is larger in a portion farther from the first foil bearing 20 and the second foil bearing 22. The radial projection 90 is disposed at a position closer to the second impeller 52 than to the first impeller 51. This configuration allows the radial projection 90 to be disposed, relative to the rotary shaft 40, at a position distant from the first foil bearing 20 and the second foil bearing 22, compared with a case where the radial projection 90 is disposed at a position closer to the first impeller 51 than to the second impeller 52, for example. This configuration allows the radial projection 90 to easily suppress the run-out of the rotary shaft 40 when the rotary shaft 40 swings before the first impeller 51 vibrates and collides with the first shroud surface 53a and the second impeller 52 vibrates and collides with the second shroud surface 53b, for example. This configuration therefore easily prevents the first impeller 51 from vibrating and colliding with the first shroud surface 53a and the second impeller 52 from vibrating and colliding with the second shroud surface 53b.
(4) The inner diameter r1 of the radial projection 90 is smaller than the minimum diameter of the first impeller 51 and the minimum diameter of the second impeller 52. Compared with a case where the inner diameter r1 of the radial projection 90 is equal to or larger than the minimum diameter of the first impeller 51 and the minimum diameter of the second impeller 52, for example, this configuration decreases the peripheral velocity of the rotary shaft 40 at the time of the collision of the rotary shaft 40 with the collision surface 90a of the radial projection 90, thereby reducing a load applied to the radial projection 90. Note that “the peripheral velocity of the rotary shaft 40” is a distance the rotary shaft 40 moves in one second on the outer periphery of the rotary shaft 40.
(5) The clearance C10 formed by the radial projection 90 is set to size that allows the deformation of the bump foil 73 in the elastic region. Even in the fluid machine 10 including the radial projection 90, this configuration allows the deformation of the bump foil 73 in the elastic region due to a dynamic pressure when the dynamic pressure is generated between the rotary shaft 40 and the top foil 72 during the rotation of the rotary shaft 40. This configuration therefore allows the top foil 72 to support the rotary shaft 40 rotatably without contacting the rotary shaft 40.
(6) The collision of the rotary shaft 40 with the collision surface 90a of the radial projection 90 prevents the rotary shaft 40 from vibrating greater, thereby preventing the rotary shaft 40 from crushing the bump foil 73 until the bump foil 73 reaches a plastic region exceeding the elastic region. This therefore prevents plastic deformation of the bump foil 73.
(7) The radial projection 90 is made of aluminum and the rotary shaft 40 is made of iron. Accordingly, the rigidity of the radial projection 90 is lower than the rigidity of the rotary shaft 40. This allows rotational stability of the rotary shaft 40 to be easily maintained at the time when the rotary shaft 40 collides with the collision surface 90a of the radial projection 90.

Note that the aforementioned embodiment may be implemented with the following modifications. The aforementioned embodiment and the following modifications may be combined with each other within a technically consistent range.

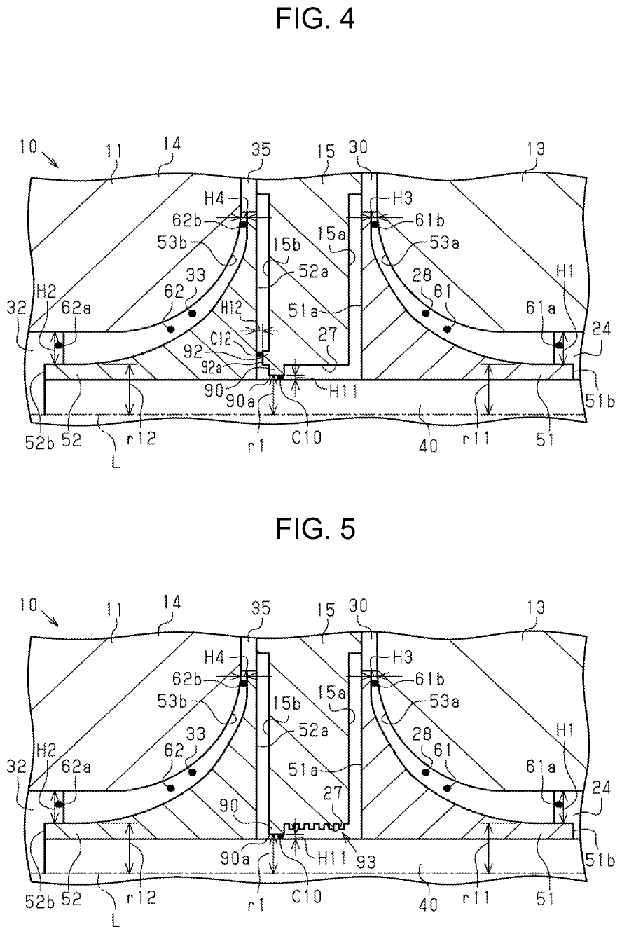

As illustrated in FIG. 4, the fluid machine 10 may further include a second thrust projection 92 having an annular shape. The second thrust projection 92 projects in the thrust direction from the second facing surface 15b. The second thrust projection 92 projects from the second facing surface 15b toward the rear surface 52a of the second impeller 52. That is, the second thrust projection 92 is provided in a gap between the rear surface 52a of the second impeller 52 and the second facing surface 15b of the partition wall 15. The second thrust projection 92 is a projection projecting from one surface of the second facing surface 15b and the rear surface 52a of the second impeller 52 toward the other surface of the second facing surface 15b and the rear surface 52a of the second impeller 52. The distal end face of the second thrust projection 92 is a collision surface 92a that collides with the rear surface 52a of the second impeller 52 when the first impeller 51 and the second impeller 52 vibrate. Therefore, in the embodiment illustrated in FIG. 4, the projection includes the radial projection 90 and the second thrust projection 92.

The second thrust projection 92 is disposed at a position closer to the second impeller 52 than to the first impeller 51. The second thrust projection 92 is located at an end portion of the second facing surface 15b adjacent to the through hole 27. The second thrust projection 92 is located in the inner peripheral portion of the second facing surface 15b. The second thrust projection 92 continues to the radial projection 90. The second thrust projection 92 is formed integrally with the partition wall 15. Accordingly, the second thrust projection 92 is made of aluminum. Note that the length of the second thrust projection 92 in the thrust direction is equal to or larger than the thickness of a blade of the second impeller 52.

Length H12 of a clearance C12 between the distal end face of the second thrust projection 92 and the rear surface 52a of the second impeller 52 in the thrust direction is smaller than the length H3 of the first thrust clearance 61b and the length H4 of the second thrust clearance 62b. Accordingly, the second thrust projection 92 cooperates with the rear surface 52a of the second impeller 52 facing the second thrust projection 92 to form therebetween the clearance C12, which is smaller than the first thrust clearance 61b and the second thrust clearance 62b in the thrust direction. The clearance C12 formed by the second thrust projection 92 is set to size that allows the deformation of the bump foil 73 in the elastic region.

The rear surface 52a of the second impeller 52 collides with the collision surface 92a of the second thrust projection 92 before the first impeller 51 vibrates in the thrust direction and collides with the first shroud surface 53a and the second impeller 52 vibrates in the thrust direction and collides with the second shroud surface 53b. Accordingly, the collision surface 92a of the second thrust projection 92 restricts vibration of the rotary shaft 40 in the thrust direction before the first impeller 51 vibrates in the thrust direction and collides with the first shroud surface 53a and the second impeller 52 vibrates in the thrust direction and collides with the second shroud surface 53b. This prevents the first impeller 51 from vibrating in the thrust direction and colliding with the first shroud surface 53a and the second impeller 52 from vibrating in the thrust direction and colliding with the second shroud surface 53b, thereby increasing the reliability of the fluid machine 10. This eliminates the need to secure the first thrust clearance 61b and the second thrust clearance 62b to a certain degree so as to prevent the first impeller 51 from vibrating in the thrust direction and colliding with the first shroud surface 53a and the second impeller 52 from vibrating in the thrust direction and colliding with the second shroud surface 53b. Accordingly, this suppresses the decrease of the compression efficiency of the fluid machine 10. Therefore, the fluid machine 10 is capable of increasing the reliability while suppressing the decrease of the compression efficiency.

The rigidity of the aluminum material of the first impeller 51 and the second impeller 52 is lower than the rigidity of the aluminum material of the partition wall 15. That is, the rigidity of the second thrust projection 92 is higher than the rigidity of the second impeller 52. Further, the length of the second thrust projection 92 in the thrust direction is equal to or larger than the thickness of the blade of the second impeller 52. This prevents the second thrust projection 92 from being damaged when the rear surface 52a of the second impeller 52 collides with the collision surface 92a of the second thrust projection 92. This therefore allows the second thrust projection 92 to easily restrict the vibration of the rotary shaft 40 in the thrust direction.

For example, the collision surface 92a of the second thrust projection 92 may be coated. Examples of coating include resin coating and metal plating. The rigidity of the second thrust projection 92 may be lower than the rigidity of the second impeller 52.

As illustrated in FIG. 5, the fluid machine 10 may include a seal portion 93 that seals the gap between the rotary shaft 40 and the inner peripheral surface of the through hole 27. The seal portion 93 is, for example, a labyrinth seal. The seal portion 93 is provided in a part of the through hole 27 other than a part of the through hole 27 where the radial projection 90 projects. That is, the radial projection 90 is disposed at a position not overlapping the seal portion 93. This allows the seal portion 93 to suitably seal the gap between the rotary shaft 40 and the inner peripheral surface of the through hole 27 and prevents the first impeller 51 from vibrating in the radial direction and colliding with the first shroud surface 53a and the second impeller 52 from vibrating in the radial direction and colliding with the second shroud surface 53b. This therefore further increases the reliability of the fluid machine 10.

In the embodiment illustrated in FIG. 5, the radial projection 90 may be disposed at a position overlapping the seal portion 93.

In the embodiment illustrated in FIG. 5, the seal portion 93 is a labyrinth seal, but the seal portion 93 is not limited thereto, and may be a seal ring. If the seal portion 93 is a seal ring, the seal ring forms a through hole through which the rotary shaft 40 is inserted and which penetrates through the partition wall 15. For example, the radial projection 90 may project in the radial direction from the inner peripheral surface of the seal ring.

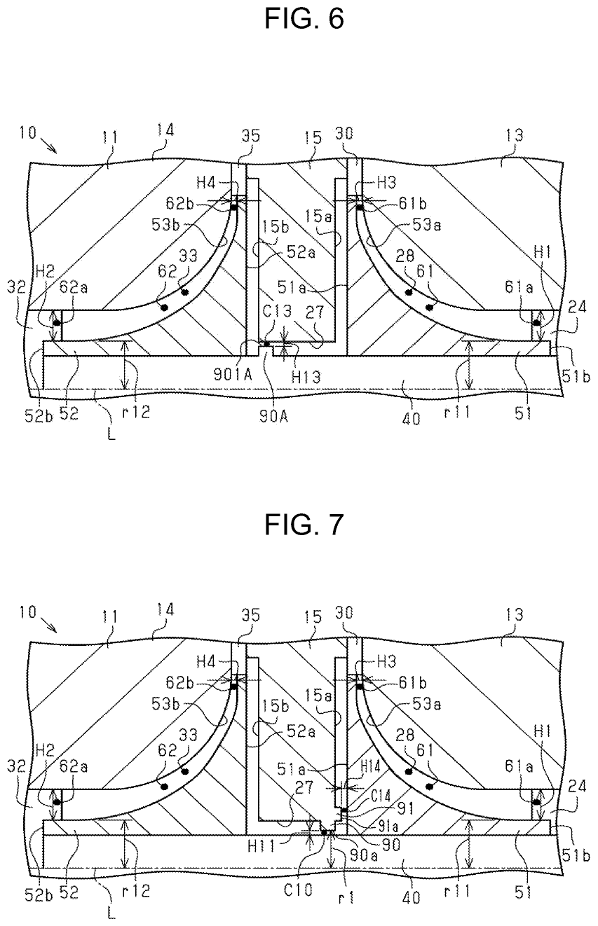

As illustrated in FIG. 6, a radial projection 90A having an annular shape may project in the radial direction from the outer peripheral surface of the rotary shaft 40. The radial projection 90A projects from the outer peripheral surface of the rotary shaft 40 toward the inner peripheral surface of the through hole 27. That is, the radial projection 90A is provided in the gap between the outer peripheral surface of the rotary shaft 40 and the inner peripheral surface of the through hole 27. The radial projection 90A is a projection projecting from one surface of the outer peripheral surface of the rotary shaft 40 and the inner peripheral surface of the through hole 27 toward the other surface of the outer peripheral surface of the rotary shaft 40 and the inner peripheral surface of the through hole 27. The outer peripheral surface of the radial projection 90A is a collision surface 901A that collides with the inner peripheral surface of the through hole 27 when the first impeller 51 and the second impeller 52 vibrate.

Length H13 of a clearance C13 between the collision surface 901A of the radial projection 90A and the inner peripheral surface of the through hole 27 in the radial direction is smaller than the length H1 of the first radial clearance 61a and the length H2 of the second radial clearance 62a. That is, the radial projection 90A cooperates with the outer peripheral surface of the through hole 27 facing the radial projection 90A to form therebetween the clearance C13, which is smaller than the first radial clearance 61a and the second radial clearance 62a in the radial direction. The clearance C13 formed by the radial projection 90A is set to size that allows the deformation of the bump foil 73 in the elastic region.

As illustrated in FIG. 7, the radial projection 90 may be disposed at a position closer to the first impeller 51 than to the second impeller 52.

As illustrated in FIG. 7, the fluid machine 10 may further include a first thrust projection 91 having an annular shape. The first thrust projection 91 projects in the thrust direction from the first facing surface 15a. The first thrust projection 91 projects from the first facing surface 15a toward the rear surface 51a of the first impeller 51. That is, the first thrust projection 91 is provided in a gap between the rear surface 51a of the first impeller 51 and the first facing surface 15a of the partition wall 15. The first thrust projection 91 is a projection that projects from one surface of the first facing surface 15a and the rear surface 51a of the first impeller 51 toward the other surface of the first facing surface 15a and the rear surface 51a of the first impeller 51. The distal end face of the first thrust projection 91 is a collision surface 91a that collides with the rear surface 51a of the first impeller 51 when the first impeller 51 and the second impeller 52 vibrate. Therefore, in the embodiment illustrated in FIG. 7, the projection includes the radial projection 90 and the first thrust projection 91.

The first thrust projection 91 is disposed at a position closer to the first impeller 51 than to the second impeller 52. The first thrust projection 91 is located at an end portion of the first facing surface 15a adjacent to the through hole 27. The first thrust projection 91 is located in the inner peripheral portion of the first facing surface 15a. The first thrust projection 91 is formed integrally with the partition wall 15. Accordingly, the first thrust projection 91 is made of aluminum. Note that the length of the first thrust projection 91 in the thrust direction is equal to or larger than the thickness of a blade of the first impeller 51.

Length H14 of a clearance C14 between the distal end face of the first thrust projection 91 and the rear surface 51a of the first impeller 51 in the thrust direction is smaller than the length H3 of the first thrust clearance 61b and the length H4 of the second thrust clearance 62b. Therefore, the first thrust projection 91 cooperates with the rear surface 51a of the first impeller 51 facing the first thrust projection 91 to form therebetween the clearance C14, which is smaller than the first thrust clearance 61b and the second thrust clearance 62b in the thrust direction. The clearance C14 formed by the first thrust projection 91 is set to size that allows the deformation of the bump foil 73 in the elastic region.

The rear surface 51a of the first impeller 51 collides with the collision surface 91a of the first thrust projection 91 before the first impeller 51 vibrates in the thrust direction and collides with the first shroud surface 53a and the second impeller 52 vibrates in the thrust direction and collides with the second shroud surface 53b. This allows the collision surface 91a of the first thrust projection 91 to restrict the vibration of the rotary shaft 40 in the thrust direction before the first impeller 51 vibrates in the thrust direction and collides with the first shroud surface 53a and the second impeller 52 vibrates in the thrust direction and collides with the second shroud surface 53b. This prevents the first impeller 51 from vibrating in the thrust direction and colliding with the first shroud surface 53a and the second impeller 52 from vibrating in the thrust direction and colliding with the second shroud surface 53b, thereby increasing the reliability of the fluid machine 10. Furthermore, this eliminates the need to secure the first thrust clearance 61b and the second thrust clearance 62b to a certain degree so as to prevent the first impeller 51 from vibrating in the thrust direction and colliding with the first shroud surface 53a and the second impeller 52 from vibrating in the thrust direction and colliding with the second shroud surface 53b. This therefore suppresses the decrease of the compression efficiency of the fluid machine 10. Therefore, the fluid machine 10 is capable of increasing the reliability while suppressing the decrease of the compression efficiency.

The rigidity of the aluminum material of the first impeller 51 and the second impeller 52 is lower than the rigidity of the aluminum material of the partition wall 15. That is, the rigidity of the first thrust projection 91 is higher than the rigidity of the first impeller 51. Further, the length of the first thrust projection 91 in the thrust direction is equal to or larger than the thickness of the blade of the first impeller 51. This prevents the first thrust projection 91 from being damaged when the rear surface 51a of the first impeller 51 collides with the collision surface 91a of the first thrust projection 91. This therefore allows the first thrust projection 91 to easily restrict the vibration of the rotary shaft 40 in the thrust direction.

For example, the collision surface 91a of the first thrust projection 91 may be coated. Examples of coating include resin coating and metal plating. The rigidity of the first thrust projection 91 may be lower than the rigidity of the first impeller 51.

In the embodiment, the fluid machine 10 may include both the radial projection 90 projecting in the radial direction from the inner peripheral surface of the through hole 27 and the radial projection 90A projecting in the radial direction from the rotary shaft 40. Therefore, the projection provided in the gap between the outer peripheral surface of the rotary shaft 40 and the inner peripheral surface of the through hole 27 only has to project from one surface of the outer peripheral surface of the rotary shaft 40 and the inner peripheral surface of the through hole 27 toward the other surface of the outer peripheral surface of the rotary shaft 40 and the inner peripheral surface of the through hole 27.

In the embodiment, the fluid machine 10 may include a first thrust projection having an annular shape and projecting in the thrust direction from the rear surface 51a of the first impeller 51. Therefore, the projection provided in the gap between the rear surface 51a of the first impeller 51 and the first facing surface 15a of the partition wall 15 only has to project from one surface of the rear surface 51a of the first impeller 51 and the first facing surface 15a of the partition wall 15 toward the other surface of the rear surface 51a of the first impeller 51 and the first facing surface 15a of the partition wall 15.

In the embodiment, the fluid machine 10 may include a second thrust projection having an annular shape and projecting in the thrust direction from the rear surface 52a of the second impeller 52. Therefore, the projection provided in the gap between the rear surface 52a of the second impeller 52 and the second facing surface 15b of the partition wall 15 only has to project from one surface of the rear surface 52a of the second impeller 52 and the second facing surface 15b of the partition wall 15 toward the other surface of the rear surface 52a of the second impeller 52 and the second facing surface 15b of the partition wall 15.

In the embodiment, the fluid machine 10 may include both the first thrust projection 91 and the second thrust projection 92.

In the embodiment, the fluid machine 10 may include the radial projection 90, the first thrust projection 91, and the second thrust projection 92. That is, the projection only has to be provided in at least one gap among the gap between the outer peripheral surface of the rotary shaft 40 and the inner peripheral surface of the through hole 27, the gap between the rear surface 51a of the first impeller 51 and the first facing surface 15a, and the gap between the rear surface 52a of the second impeller 52 and the second facing surface 15b such that the projection projects from one surface toward the other surface.

In the embodiment, for example, the collision surface 90a of the radial projection 90 may be coated. Examples of the coating include resin coating and metal plating.

In the embodiment, for example, the rigidity of the radial projection 90 may be higher than the rigidity of the rotary shaft 40.

In the embodiment, two or more radial projections 90 may project from the inner peripheral surface of the through hole 27. For example, if two radial projections 90 project from the inner peripheral surface of the through hole 27, one of the two radial projections 90 is disposed at a position closer to the second impeller 52 than to the first impeller 51 and the other of the two radial projections 90 is disposed at a position closer to the first impeller 51 than to the second impeller 52.

In the embodiment illustrated in FIG. 4, two or more second thrust projections 92 may project from the second facing surface 15b of the partition wall 15. For example, if two second thrust projections 92 project from the second facing surface 15b, one of the two second thrust projections 92 is located in the inner peripheral portion of the second facing surface 15b and the other of the two second thrust projections 92 is located in the outer peripheral portion of the second facing surface 15b.

In the embodiment illustrated in FIG. 7, two or more first thrust projections 91 may project from the first facing surface 15a of the partition wall 15. For example, if two first thrust projections 91 project from the first facing surface 15a, one of the two first thrust projections 91 is located in the inner peripheral portion of the first facing surface 15a and the other of the two first thrust projections 91 is located in the outer peripheral portion of the first facing surface 15a.

In the embodiment illustrated in FIG. 6, two or more radial projections 90A may project from the outer peripheral surface of the rotary shaft 40. For example, if two radial projections 90A project from the outer peripheral surface of the rotary shaft 40, one of the two radial projections 90A is disposed at a position closer to the second impeller 52 than to the first impeller 51 and the other of the two radial projections 90A is disposed at a position closer to the first impeller 51 than to the second impeller 52.

In the embodiment, the inner diameter r1 of the radial projection 90 may be equal to or larger than the minimum diameter of the first impeller 51 and the minimum diameter of the second impeller 52.

In the embodiment, the fluid compressed by the first impeller 51 and the second impeller 52 is not limited to air. Therefore, the object to which the fluid machine 10 is applied and a fluid to be compressed by the fluid machine 10 are optional. For example, the fluid machine 10 may be used in an air conditioning device, and a fluid to be compressed may be refrigerant. The object to which the fluid machine 10 is mounted is not limited to a vehicle and is optional.

### REFERENCE SIGNS LIST

10 Fluid machine
11 Housing
15 Partition wall
15a First facing surface
15b Second facing surface
20 First foil bearing serving as a foil bearing
22 Second foil bearing serving as a foil bearing
27 Through hole
28 First impeller chamber
33 Second impeller chamber
40 Rotary shaft
51 First impeller
51a Rear surface
52 Second impeller
52a Rear surface
53a First shroud surface
53b Second shroud surface
61 First tip clearance
61a First radial clearance
61b First thrust clearance
62 Second tip clearance
62a Second radial clearance
62b Second thrust clearance
72 Top foil
73 Bump foil
90, 90A Radial projection serving as a projection
90a, 91a, 92a, 901A Collision surface
91 First thrust projection serving as a projection
92 Second thrust projection serving as a projection
93 Seal portion
C10, C12, C13, C14 Clearance

1. A fluid machine comprising:
a rotary shaft;
a first impeller configured to rotate together with the rotary shaft to compress a fluid;
a second impeller configured to rotate together with the rotary shaft to compress the fluid that has been compressed by the first impeller;
a housing having a first impeller chamber in which the first impeller is accommodated and a second impeller chamber in which the second impeller is accommodated; and
a foil bearing disposed in the housing and supporting the rotary shaft rotatably,
the housing including:
a partition wall separating the first impeller chamber and the second impeller chamber;
a first shroud surface cooperating with the partition wall to define the first impeller chamber and covering an outer periphery of the first impeller; and
a second shroud surface cooperating with the partition wall to define the second impeller chamber and covering an outer periphery of the second impeller,
the first impeller and the second impeller being provided in the rotary shaft such that a rear surface of the first impeller and a rear surface of the second impeller face each other via the partition wall, wherein
the partition wall has:
a first facing surface facing the rear surface of the first impeller in an axial direction of the rotary shaft; and
a second facing surface facing the rear surface of the second impeller in the axial direction of the rotary shaft,
the rotary shaft extends across the first impeller chamber and the second impeller chamber with the rotary shaft inserted through a through hole that penetrates through the partition wall,
a projection, projecting from one surface toward the other surface, is provided in at least one gap among a gap between an outer peripheral surface of the rotary shaft and an inner peripheral surface of the through hole, a gap between the rear surface of the first impeller and the first facing surface, and a gap between the rear surface of the second impeller and the second facing surface,
the projection cooperates with the other surface facing the projection to form therebetween a clearance that is smaller than a first tip clearance between the first impeller and the first shroud surface and a second tip clearance between the second impeller and the second shroud surface, and
the projection has a collision surface that collides with the other surface when the first impeller and the second impeller vibrate to prevent a contact of the first impeller with the first shroud surface and a contact of the second impeller with the second shroud surface.

2. The fluid machine according to claim 1, wherein
the first tip clearance includes a first radial clearance that extends in a radial direction between the first impeller and the first shroud surface,
the second tip clearance includes a second radial clearance that extends in the radial direction between the second impeller and the second shroud surface, and
the projection includes a radial projection that has an annular shape, projects in the radial direction from at least one of the inner peripheral surface of the through hole and the outer peripheral surface of the rotary shaft, and forms a clearance that is smaller than the first radial clearance and the second radial clearance in the radial direction.

3. The fluid machine according to claim 1, wherein
the first tip clearance includes a first thrust clearance that extends in a thrust direction between the first impeller and the first shroud surface,
the second tip clearance includes a second thrust clearance that extends in the thrust direction between the second impeller and the second shroud surface, and
the projection includes at least one of a first thrust projection having an annular shape and a second thrust projection having an annular shape, wherein the first thrust projection projects in the thrust direction from at least one of the rear surface of the first impeller and the first facing surface and forms a clearance that is smaller than the first thrust clearance and the second thrust clearance in the thrust direction, and the second thrust projection projects in the thrust direction from at least one of the rear surface of the second impeller and the second facing surface and forms a clearance that is smaller than the first thrust clearance and the second thrust clearance in the thrust direction.

4. The fluid machine according to claim 1, wherein
the second impeller is disposed closer to one end of the rotary shaft than the first impeller is,
the foil bearing is disposed closer to the other end of the rotary shaft than the first impeller and the second impeller are, and
the projection is disposed at a position closer to the second impeller than to the first impeller.

5. The fluid machine according to claim 2, wherein
the radial projection projects from the inner peripheral surface of the through hole toward the rotary shaft, and
an inner diameter of the radial projection is smaller than a minimum diameter of the first impeller and a minimum diameter of the second impeller.

6. The fluid machine according to claim 2, wherein
the fluid machine includes a seal portion that seals the gap between the rotary shaft and the inner peripheral surface of the through hole, and
the radial projection is disposed at a position not overlapping the seal portion.

7. The fluid machine according to claim 1, wherein
the foil bearing includes:
a top foil supporting the rotary shaft rotatably without contacting the rotary shaft during rotation of the rotary shaft; and
a bump foil elastically supporting the top foil, and
the clearance formed by the projection is set to size that allows deformation of the bump foil in an elastic region.

8. The fluid machine according to claim 7, wherein the foil bearing supports the rotary shaft rotatably in a place different from the partition wall of the housing.

9. The fluid machine according to claim 1, wherein the projection is formed integrally with the partition wall, and rigidity of the projection is higher than rigidity of the rotary shaft, the first impeller, and the second impeller.
